(19) United States
(12) Patent Application Publication
(10) Pub. No.: US 2015/0229164 A1
(43) Pub. Date: Aug. 13, 2015

(54) ELECTRONIC APPARATUS, POWER TRANSMITTING APPARATUS, METHOD, AND STORAGE MEDIUM

(71) Applicant: CANON KABUSHIKI KAISHA, Tokyo (JP)

(72) Inventor: Yudai Fukaya, Tokyo (JP)

(21) Appl. No.: 14/616,547

(22) Filed: Feb. 6, 2015

(30) Foreign Application Priority Data
Feb. 10, 2014 (JP) 2014-023829

(51) Int. Cl. H02J 17/00; H04B 5/00; H02J 5/00; H02J 7/02; H02J 7/00

(52) U.S. Cl. CPC H02J 17/00; H02J 7/025; H02J 7/007; H02J 5/005; H04B 5/0037

(57) ABSTRACT

An electronic apparatus includes a power receiving unit that wirelessly receives power from a power transmitting apparatus, a supply unit that supplies the power received by the power receiving unit to a load unit, and a control unit that performs control in such a manner that an impedance of the load unit matches a predetermined impedance that is set based on a Quality Factor relating to the electronic apparatus and a value indicating a level of coupling between the power transmitting apparatus and the electronic apparatus.

### BACKGROUND

1. Field

Aspects of the present invention generally relate to, for example, an electronic apparatus that receives power wirelessly transmitted from a power transmitting apparatus.

2. Description of the Related Art

In recent years, there has been known a power transmitting system including a power transmitting apparatus configured to wirelessly transmit power without requiring a connection via a connector, and an electronic apparatus configured to receive the power transmitted from the power transmitting apparatus.

Japanese Patent Application Laid-Open No. 2013-5615 discusses such a power transmitting system. In this power transmitting system, a power transmitting apparatus transmits power to an electronic apparatus according to efficiency of power transmission from the power transmitting apparatus to the electronic apparatus.

Conventionally, in some cases, the power transmission efficiency has been changed according to an impedance of a load of the electronic apparatus. Therefore, even if the power transmitting apparatus controls the power to be transmitted to the electronic apparatus according to the power transmission efficiency, the power transmission efficiency decreases in the case of a sudden change in the impedance of the load of the electronic apparatus. As a result, the electronic apparatus cannot receive sufficient power.

### SUMMARY

An aspect of the present invention is generally directed to controlling an impedance of a load connected to an electronic apparatus to enable the electronic apparatus to receive sufficient power.

According to an aspect of the present invention, an electronic apparatus includes a power receiving unit configured to wirelessly receive power from a power transmitting apparatus, a supply unit configured to supply power received by the power receiving unit to a load unit, and a control unit configured to perform control such that an impedance of the load unit matches a predetermined impedance. The predetermined impedance is set based on a Quality Factor relating to the electronic apparatus and a value indicating a level of coupling between the power transmitting apparatus and the electronic apparatus.

Further aspects of the present invention will become apparent from the following description of exemplary embodiments.

### BRIEF DESCRIPTION OF THE DRAWINGS

FIG. 1 illustrates one example of a power transmitting system according to a first exemplary embodiment.

FIG. 2 is a block diagram illustrating one example of a power transmitting apparatus according to the first exemplary embodiment.

FIG. 3 is a block diagram illustrating one example of an electronic apparatus according to the first exemplary embodiment.

FIGS. 4A and 4B illustrate one example of a configuration of a power transmitting antenna according to the first exemplary embodiment, and one example of a configuration of a power receiving antenna according to the first exemplary embodiment, respectively.

FIG. 5 is a flowchart illustrating one example of a power transmitting process according to the first exemplary embodiment.

FIG. 6 is a flowchart illustrating one example of a power receiving process according to the first exemplary embodiment.

FIG. 7 is a flowchart illustrating one example of a control process according to the first exemplary embodiment.

### DESCRIPTION OF THE EMBODIMENTS

Various exemplary embodiments, features, and aspects of the present disclosure will be described below with reference to the drawings.

In the following description, a first exemplary embodiment will be described with reference to the drawings.

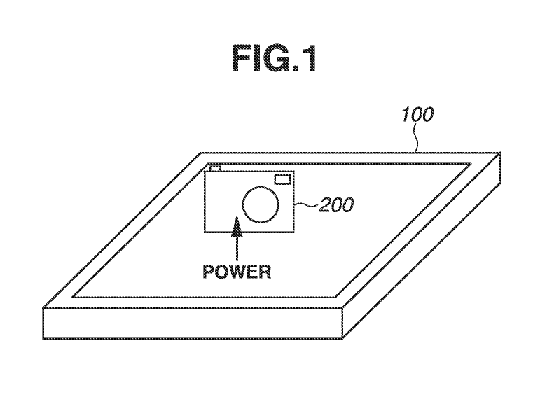

As illustrated in FIG. 1, a power transmitting system according to the first exemplary embodiment includes a power transmitting apparatus 100 and an electronic apparatus 200. The power transmitting apparatus 100 wirelessly outputs power to the electronic apparatus 200. The electronic apparatus 200 wirelessly receives the power output from the power transmitting apparatus 100. The power transmitting apparatus 100 may wirelessly output power to a plurality of apparatuses having similar functions to the electronic apparatus 200.

Further, the electronic apparatus 200 may be a movable member such as a vehicle, or a mobile apparatus such as a digital camera and a mobile phone, and may be a battery pack.

The power transmitting system according to the first exemplary embodiment will be described below as a system in which the power transmitting apparatus 100 outputs the power to the electronic apparatus 200 by electromagnetic resonance, and the electronic apparatus 200 receives the power from the power transmitting apparatus 100 by the electromagnetic resonance. However, another method may be used when the power transmitting apparatus 100 transmits the power to the electronic apparatus 200, instead of the electromagnetic resonance method.

### (Power Transmitting Apparatus 100)

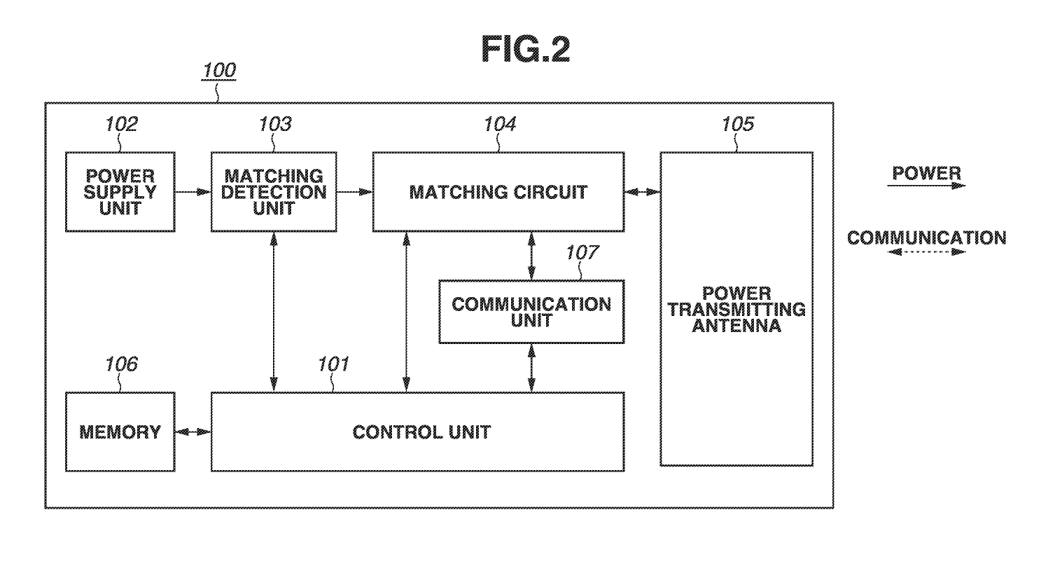

The power transmitting apparatus 100 will be described with reference to FIG. 2. As illustrated in FIG. 2, the power transmitting apparatus 100 includes a control unit 101, a power supply unit 102, a matching detection unit 103, a matching circuit 104, a power transmitting antenna 105, a memory 106, and a communication unit 107.

The control unit 101 controls each unit of the power transmitting apparatus 100 according to a program recorded in the memory 106. The control unit 101 is, for example, a central processing unit (CPU). Further, the control unit 101 is realized by hardware.

The power supply unit 102 generates power to be output outwardly via the power transmitting antenna 105. After that, the power supply unit 102 supplies the generated power to the power transmitting antenna 105 via the matching detection unit 103 and the matching circuit 104.

The matching detection unit 103 measures a voltage of a traveling wave of the power generated by the power supply unit 102, and a voltage of a reflection wave from the matching circuit 104. After that, the matching detection unit 103 detects a voltage standing wave ratio (VSWR) with use of the measured voltage of the traveling wave of the power and the measured voltage of the reflection wave of the power. The control unit 101 detects whether there is any object in the proximity of the power transmitting apparatus 100 with use of the VSWR detected by the matching detection unit 103. For example, a directional coupler is used as the matching detection unit 103.

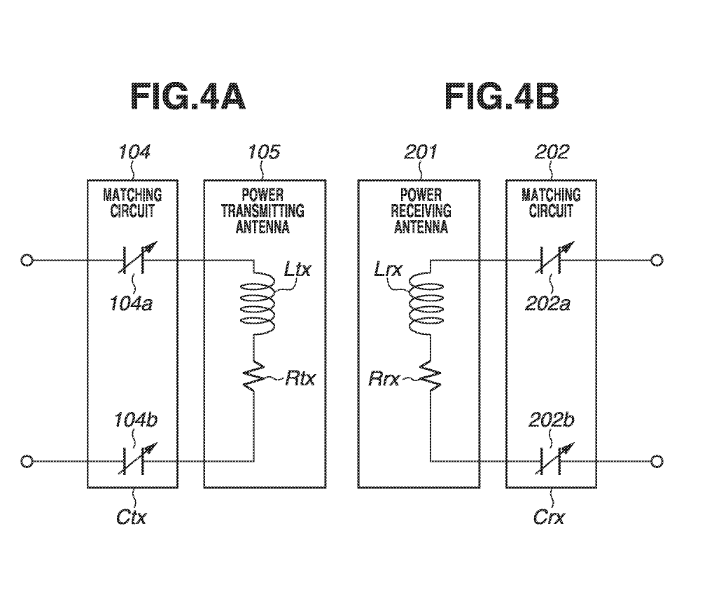

The matching circuit 104 is a resonance circuit for achieving resonance between the power transmitting antenna 105 and a power receiving antenna 201. The matching circuit 104 includes, for example, variable capacitors 104a and 104b, as illustrated in FIG. 4A.

When the power transmitting apparatus 100 transmits the power via the power transmitting antenna 105, the control unit 101 controls a value of a capacitance of at least one of the variable capacitors 104a and 104b to set a resonance frequency of the power transmitting antenna 105 to a predetermined frequency.

The predetermined frequency may be 50 to 60 Hz, which are commercial frequencies. It may also be 10 to several hundred kHz, and may be a frequency around 10 MHz. Further, the predetermined frequency may be 150 to 250 kHz. Furthermore, the predetermined frequency may be 13.56 MHz, or 6.78 MHz.

The power transmitting antenna 105 is an antenna for transmitting the power generated by the power supply unit 102 to the electronic apparatus 200.

The power transmitting antenna 105 includes, for example, a coil Ltx and an internal resistance Rtx, as illustrated in FIG. 4A.

The control unit 101 calculates a Quality Factor that indicates a level of resonance of the power transmitting antenna 105. Hereinafter, the Quality Factor of the power transmitting antenna 105 will be referred to as a “Qtx”.

The following expression indicates one example of an expression for calculating the Qtx.

$$Qtx = \frac{1}{Rtx} \sqrt{\frac{Ltx}{Ctx}} \qquad ( 1 )$$

In the expression (1), Ltx is a value of an inductance of the coil Ltx illustrated in FIG. 4A. In the expression (1), Ctx is a value of a capacitance of the variable capacitors 104a and 104b illustrated in FIG. 4A. In the expression (1), Rtx is a value of an impedance of the internal resistance Rtx illustrated in FIG. 4A.

The memory 106 stores the computer program for controlling operations of each unit of the power transmitting apparatus 100, information regarding the operations of the respective units, information received from the electronic apparatus 200, and the like. Assume that the memory 106 stores the value of the inductance of the coil Ltx, the value of the capacitance of the variable capacitors 104a and 104b, and the value of the impedance of the internal resistance Rtx.

The communication unit 107 performs wireless communication with the electronic apparatus 200 based on a predetermined protocol. The predetermined protocol is, for example, a protocol defined by the Near Field Communication (NFC) standards.

The communication unit 107 superposes a command onto the power by performing amplitude-shift keying (ASK) modulation on the power supplied from the power supply unit 102 to the matching circuit 104. The power with the command superposed thereon is transmitted to the electronic apparatus 200 via the power transmitting antenna 105. When the electronic apparatus 200 receives the command from the communication unit 107, the electronic apparatus 200 changes a load inside the electronic apparatus 200 to transmit response data that is a response to the received command. As a result, a change occurs in a current flowing through the power transmitting antenna 105. Therefore, the communication unit 107 receives the response data from the electronic apparatus 200 by detecting the change in the current flowing through the power transmitting antenna 105, and demodulating it.

### (Electronic Apparatus 200)

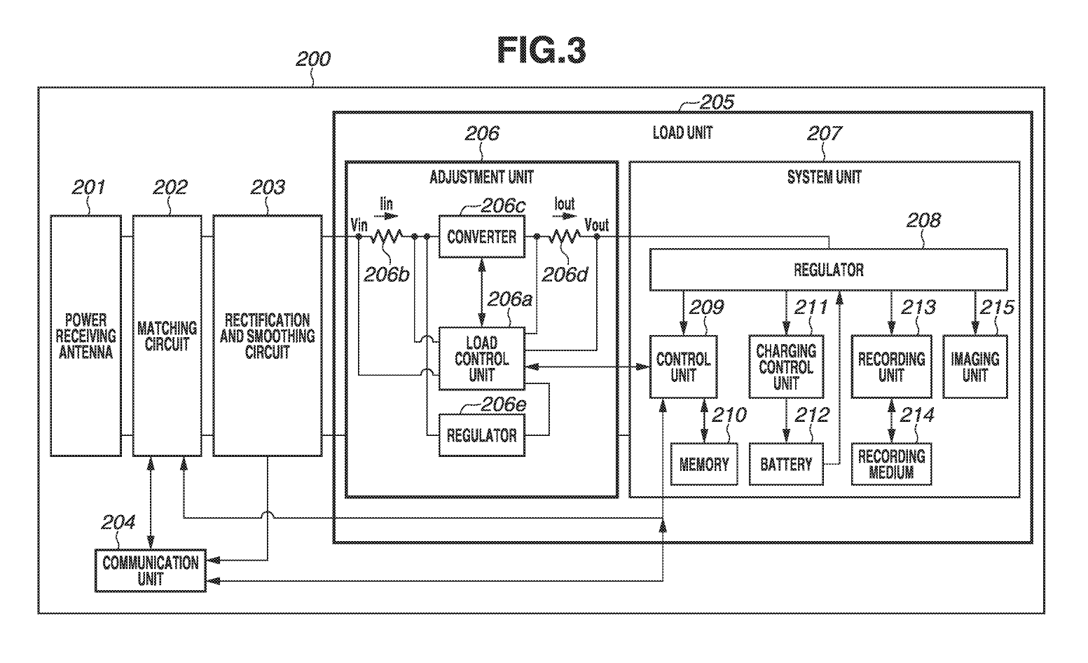

The electronic apparatus 200 will be described with reference to FIG. 3. As illustrated in FIG. 3, the electronic apparatus 200 includes the power receiving antenna 201, a matching circuit 202, a rectification and smoothing circuit 203, a communication unit 204, and a load unit 205.

The power receiving antenna 201 is an antenna for receiving the power supplied from the power transmitting apparatus 100. The power received by the power receiving antenna 201 is supplied to the rectification and smoothing circuit 203 via the matching circuit 202.

The power receiving antenna 201 includes, for example, a coil Lrx and an internal resistance Rrx, as illustrated in FIG. 4B.

The matching circuit 202 is a resonance circuit for achieving resonance between the power receiving antenna 201 and the power transmitting antenna 105. The matching circuit 202 includes, for example, variable capacitors 202a and 202b, as illustrated in FIG. 4B.

When the electronic apparatus 200 receives the power via the power receiving antenna 201, a control unit 209, which will be described below, controls a value of a capacitance of at least one of the variable capacitors 202a and 202b to set a resonance frequency of the power receiving antenna 201 to the predetermined frequency.

The rectification and smoothing circuit 203 removes the command from the power received by the power receiving antenna 201, and generates direct-current power. The direct-current power generated by the rectification and smoothing circuit 203 is supplied to a system unit 207 via an adjustment unit 206. The command removed by the rectification and smoothing circuit 203 is supplied to the communication unit 204.

The communication unit 204 receives the command supplied from the rectification and smoothing circuit 203, and supplies the received command to the control unit 209. Further, the communication unit 204 performs load modulation to transmit the response data in response to the command received from the power transmitting apparatus 100. The control unit 209 controls the electronic apparatus 200 according to the command received from the power transmitting apparatus 100. Further, the control unit 209 controls the communication unit 204 to transmit the response data to the power transmitting apparatus 100.

Next, the load unit 205 will be described. As illustrated in FIG. 2, the load unit 205 includes the adjustment unit 206 and the system unit 207.

The adjustment unit 206 makes an adjustment so as to keep an impedance of the load unit 205 constant. Further, the adjustment unit 206 controls the power to be supplied from the rectification and smoothing circuit 203 to the system unit 207.

The adjustment unit 206 includes a load control unit 206a, a first current detection resistance 206b, a converter 206c, a second current detection resistance 206d, and a regulator 206e.

The load control unit 206a detects a current flowing through the first current detection resistance 206b, and detects a current flowing through the second current detection resistance 206d. Hereinafter, the current flowing through the first current detection resistance 206b will be referred to as an “input current Iin”, and the current flowing through the second current detection resistance 206d will be referred to as an “output current Iout”.

Further, the load control unit 206a detects a voltage input from the rectification and smoothing circuit 203 to the adjustment unit 206, and detects a voltage output from the adjustment unit 206 to the system unit 207. Hereinafter, the voltage input from the rectification and smoothing circuit 203 to the adjustment unit 206 will be referred to as an “input voltage Vin”, and the voltage output from the adjustment unit 206 to the system unit 207 will be referred to as an “output voltage Vout”.

Further, the load control unit 206a controls the converter 206c according to the input current Iin, the output current Iout, the input voltage Vin, and the output voltage Vout.

The converter 206c controls the voltage to be supplied to the system unit 207 by converting the voltage input from the rectification and smoothing circuit 203 to the adjustment unit 206 according to an instruction from the load control unit 206a. The load control unit 206a controls the converter 206c in such a manner that the voltage to be supplied to the system unit 207 does not fall below a voltage required to allow the control unit 209 and a charging control unit 211 to operate.

The regulator 206e converts the voltage input via the first current detection resistance 206b into an operation voltage of the load control unit 206a, and supplies the converted voltage to the load control unit 206a.

The system unit 207 includes a regulator 208, the control unit 209, a memory 210, the charging control unit 211, a battery 212, a recording unit 213, a recording medium 214, and an imaging unit 215.

The regulator 208 converts the voltage Vout input from the adjustment unit 206 into an appropriate voltage, and supplies the converted voltage to at least one of the control unit 209, the memory 210, the charging control unit 211, the battery 212, the recording unit 213, the recording medium 214, and the imaging unit 215.

Further, the regulator 208 can also convert a voltage supplied from the battery 212 into an appropriate voltage, and supply the converted voltage to at least one of the control unit 209, the memory 210, the charging control unit 211, the recording unit 213, the recording medium 214, and the imaging unit 215.

The control unit 209 controls the electronic apparatus 200 by executing a computer program stored in the memory 210. The control unit 209 can also acquire data from the load control unit 206a, or control the load control unit 206a. The control unit 209 is, for example, a CPU, and is realized by hardware.

The control unit 209 calculates a Quality Factor that indicates a level of resonance of the power receiving antenna 201. Hereinafter, the Quality Factor of the power receiving antenna 201 will be referred to as a “Qrx”.

The following expression indicates one example of an expression for calculating the Qrx.

$$Qrx = \frac{1}{Rrx} \sqrt{\frac{Lrx}{Crx}} \qquad ( 2 )$$

In the expression (2), Lrx is a value of an inductance of the coil Lrx illustrated in FIG. 4B. In the expression (2), Crx is a value of a capacitance of the variable capacitors 202a and 202b illustrated in FIG. 4B. In the expression (2), Rrx is a value of an impedance of the internal resistance Rrx illustrated in FIG. 4B.

The memory 210 stores the computer program for controlling an operation of the electronic apparatus 200, and information of a parameter regarding the electronic apparatus 200 and the like. The memory 210 stores the value of the inductance of the coil Lrx, the value of the capacitance of the variable capacitors 202a and 202b, and the value of the impedance of the internal resistance Rrx.

The charging control unit 211 charges the battery 212 with the voltage supplied from the regulator 208. Further, the charging control unit 211 periodically detects information indicating a remaining capacity of the battery 212 connected to the electronic apparatus 200, and supplies the detected information to the control unit 209. Hereinafter, the information indicating the remaining capacity of the battery 212 that is supplied from the charging control unit 211 will be referred to as “remaining capacity information”. The battery 212 is a secondary battery connectable to the electronic apparatus 200.

The recording unit 213 records video data supplied from the imaging unit 215 into the recording medium 214. Further, the recording unit 213 can also read out video data and audio data from the recording medium 214. The recording medium 214 may be an internal memory of the electronic apparatus 200, or may be an external memory connectable to the electronic apparatus 200.

The imaging unit 215 generates image data such as a still image, a moving image, and the like from an optical image of a subject, and supplies the generated image data to the recording unit 213.

### (Power Transmitting Process)

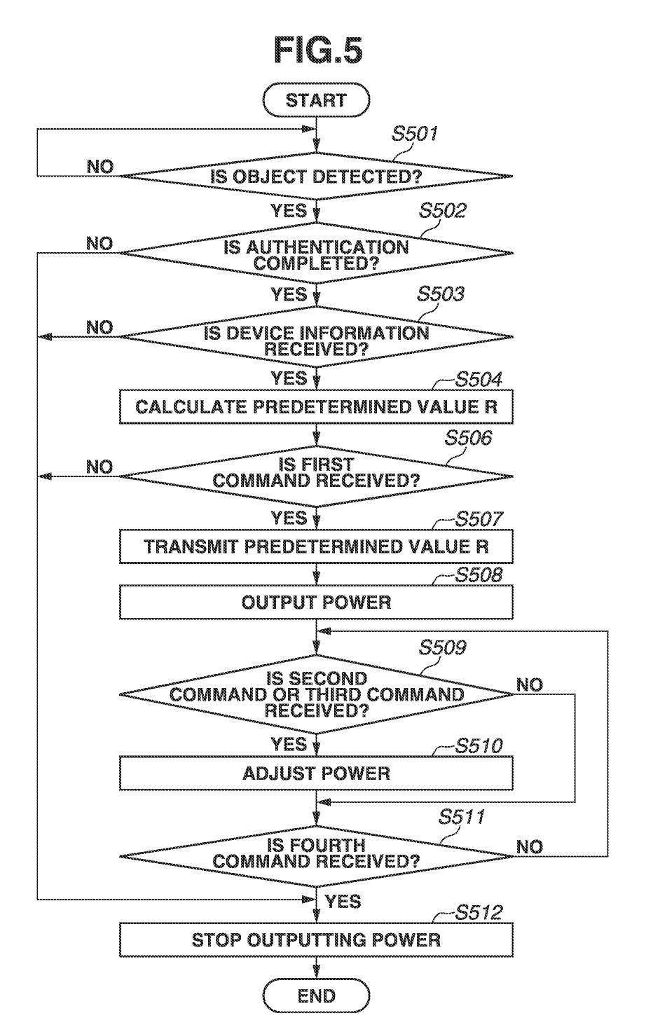

A power transmitting process performed by the power transmitting apparatus 100 will be described with reference to a flowchart illustrated in FIG. 5. The control unit 101 executes the computer program stored in the memory 106 to realize the power transmitting process illustrated in FIG. 5.

In step S501, the control unit 101 detects whether there is any object in the proximity of the power transmitting apparatus 100 according to the VSWR detected by the matching detection unit 103. If the control unit 101 detects that there is an object (YES in step S501), the process proceeds to step S502. If the control unit 101 does not detect that there is an object (NO in step S501), the control unit 101 repeats step S501.

In step S502, the control unit 101 determines whether authentication for transmitting power is completed. For example, the control unit 101 controls the communication unit 107 in such a manner that the communication unit 107 transmits an authentication command for requesting authentication to the object detected in step S501. After that, the control unit 101 determines whether response data as a response to the authentication command is received by the communication unit 107. If the response data as a response to the authentication request command is received by the communication unit 107, the control unit 101 determines that the object detected in step S501 is the electronic apparatus 200, and determines that the authentication for transmitting power is completed (YES in step S502). In this case (YES in step S502), the process proceeds to step S503. If the response data as a response to the authentication request is not received by the communication unit 107, the control unit 101 determines that the object detected in step S501 is not the electronic apparatus 200 (NO in step S502), and then the process proceeds to step S512.

In step S503, the control unit 101 determines whether device information is received by the communication unit 107 from the electronic apparatus 200. The device information includes, for example, at least the Quality Factor Qrx detected by the electronic apparatus 200 and the value of the impedance of the internal resistance Rrx of the power receiving antenna 201.

For example, the control unit 101 controls the communication unit 107 in such a manner that the communication unit 107 transmits an acquisition command for acquiring the device information from the electronic apparatus 200. After that, the control unit 101 determines whether the device information is received by the communication unit 107 as response data transmitted in response to the acquisition command. If the device information is received by the communication unit 107 (YES in step S503), the process proceeds to step S504. If the device information is not received by the communication unit 107 (NO in step S503), the process proceeds to step S512.

When the electronic apparatus 200 is detected, the power transmitting apparatus 100 transmits power requested from the electronic apparatus 200, and then the electronic apparatus 200 charges the battery 212 with the power received from the power transmitting apparatus 100.

The power transmitting apparatus 100 has to transmit the power to the electronic apparatus 200 while maintaining high efficiency in the power transmission, from the power transmitting apparatus 100 to the electronic apparatus 200, so as to allow the electronic apparatus 200 to efficiently charge the battery 212. However, while the battery 212 is being charged, the impedance of the load unit 205 of the electronic apparatus 200 is changed according to a charging state of the battery 212 and the remaining capacity of the battery 212. In this case, the power received from the power transmitting apparatus 100 and the power transmission efficiency may be reduced in the electronic apparatus 200 according to the change in the impedance of the load unit 205. As a result, the electronic apparatus 200 may be unable to receive desired power from the power transmitting apparatus 100.

Therefore, the electronic apparatus 200 has to acquire a predetermined value R for increasing the power transmission efficiency, and perform control in such a manner that the impedance of the load unit 205 matches the predetermined value R even while the battery 212 is being charged. The power transmission efficiency indicates a ratio of power received by the power receiving antenna 201 of the electronic apparatus 200 to power output by the power transmitting apparatus 100 via the power transmitting antenna 105.

Therefore, in step S504, the control unit 101 calculates the predetermined value R with use of the device information acquired from the electronic apparatus 200. The predetermined value R is a target value for controlling the impedance of the load unit 205.

The following expression indicates one example of an expression for calculating the predetermined value R.

R=Rrx×\sqrt{1+k²QtxQrx} (3)

In the expression (3), Rrx is a value contained in the device information received from the electronic apparatus 200. In the expression (3), Qtx is a value calculated by the control unit 101 according to the expression (1). In the expression (3), Qrx is a value contained in the device information received from the electronic apparatus 200. In the expression (3), k is a value detected by the control unit 101. More specifically, k is a coupling coefficient that indicates a level of coupling between the power transmitting antenna 105 and the power receiving antenna 201. The coupling coefficient k is a value varying according to a distance between the power transmitting antenna 105 and the power receiving antenna 201, an orientation of the power receiving antenna 201 with respect to the power transmitting antenna 105, and the like.

After the control unit 101 calculates the predetermined value R according to the expression (3), the process proceeds to step S506.

In step S506, the control unit 101 determines whether a first command for requesting power transmission is received by the communication unit 107 from the electronic apparatus 200. If the first command is received by the communication unit 107 (YES in step S506), the process proceeds to step S507. If the first command is not received by the communication unit 107 (NO in step S506), the process proceeds to step S512.

In step S507, the control unit 101 controls the communication unit 107 in such a manner that the communication unit 107 transmits the predetermined value R calculated in step S504 to the electronic apparatus 200. After that, the process proceeds to step S508. In step S508, the control unit 101 controls at least one of the power supply unit 102 and the matching circuit 104 in such a manner that power is output to the electronic apparatus 200. After that, the process proceeds to step S509.

In step S509, the control unit 101 determines whether an increase or a reduction in the power transmitted to the electronic apparatus 200 is requested. Hereinafter, the power transmitted from the power transmitting apparatus 100 to the electronic apparatus 200 will be referred to as power-transmission power. If a second command for requesting an increase in the power-transmission power is received by the communication unit 107, the control unit 101 determines that an increase in the power-transmission power is requested from the electronic apparatus 200 (YES in step S509), and then the process proceeds to step S510. If a third command for requesting a reduction in the power-transmission power is received by the communication unit 107, the control unit 101 determines that a reduction in the power-transmission power is requested from the electronic apparatus 200 (YES in step S509), and then the process proceeds to step S510. If the second command and the third command are not received by the communication unit 107, the control unit 101 determines that an increase and a reduction in the power-transmission power are not requested from the electronic apparatus 200 (NO in step S509), and then the process proceeds to step S511.

In step S510, the control unit 101 adjusts the power-transmission power according to the command received by the communication unit 107 from the electronic apparatus 200. If the second command is received by the communication unit 107, the control unit 101 controls at least one of the power supply unit 102 and the matching circuit 104 in such a manner that the power-transmission power is increased. If the third command is received by the communication unit 107, the control unit 101 controls at least one of the power supply unit 102 and the matching circuit 104 in such a manner that the power-transmission power is reduced. After the power-transmission power is adjusted, the process proceeds to step S511.

In step S511, the control unit 101 determines whether a fourth command for requesting a stop of the power transmission is received by the communication unit 107 from the electronic apparatus 200. If the fourth command is received by the communication unit 107 (YES in step S511), the process proceeds to step S512. If the fourth command is not received by the communication unit 107 (NO in step S511), the process proceeds to step S509.

In step S512, the control unit 101 controls at least one of the power supply unit 102 and the matching circuit 104 in such a manner that the power output is stopped. After that, the present flowchart ends.

### (Power Receiving Process)

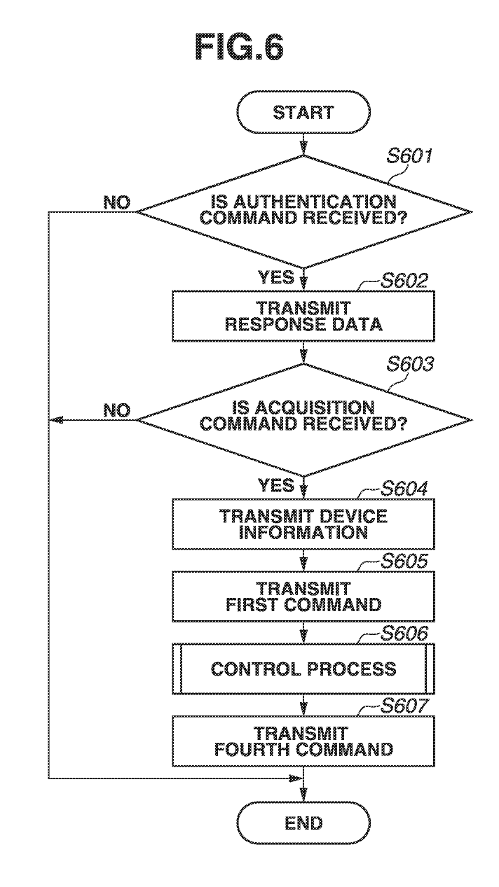

A power receiving process performed by the power receiving apparatus 200 will be described with reference to a flowchart illustrated in FIG. 6. The control unit 209 executes the computer program stored in the memory 210 to realize the power receiving process illustrated in FIG. 6.

In step S601, the control unit 209 determines whether the authentication command is received by the communication unit 204. If the authentication command is received by the communication unit 204 (YES in step S601), the process proceeds to step S602. If the authentication command is not received by the communication unit 204 (NO in step S601), the present flowchart ends. In step S602, the control unit 209 controls the communication unit 204 in such a manner that the communication unit 204 transmits the response data corresponding to the authentication command. Then, the process proceeds to step S603.

In step S603, the control unit 209 determines whether the acquisition command is received by the communication unit 204. If the acquisition command is received by the communication unit 204 (YES in step S603), the process proceeds to step S604. If the acquisition command is not received by the communication unit 204 (NO in step S603), the present flowchart ends.

In step S604, the control unit 209 generates the device information that contains the Quality Factor Qrx calculated according to the expression (2) and the value of the impedance of the internal resistance Rrx that is read out from the memory 210. Further, the control unit 209 controls the communication unit 204 in such a manner that the communication unit 204 transmits the generated device information to the power transmitting apparatus 100. After that, the process proceeds to step S605.

In step S605, the control unit 209 controls the communication unit 204 in such a manner that the communication unit 204 transmits the first command to the power transmitting apparatus 100. Then, the process proceeds to step S606. After the first command is transmitted, direct-current power is supplied to the load unit 205 according to the power received by the power receiving antenna 201 from the power transmitting apparatus 100.

The control unit 209 controls the charging control unit 211 in such a manner that the charging control unit 211 charges the battery 212 with the power received by the power receiving antenna 201 from the power transmitting apparatus 100 after the first command is transmitted. Further, the control unit 209 may control the recording unit 213 in such a manner that the recording unit 213 reads out or records data with use of the power received by the power receiving antenna 201 from the power transmitting apparatus 100 after the first command is transmitted. Further, the control unit 209 may control the imaging unit 215 in such a manner that the imaging unit 215 generates image data with use of the power received by the power receiving antenna 201 from the power transmitting apparatus 100 after the first command is transmitted.

In step S606, the control unit 209 performs a control process so that the impedance of the load unit 205 matches the predetermined value R. The control process will be described below. After the control process is performed, the process proceeds to step S607. In step S607, the control unit 209 controls the communication unit 204 in such a manner that the communication unit 204 transmits the fourth command to the power transmitting apparatus 100. Then, the present flowchart ends.

### (Control Process)

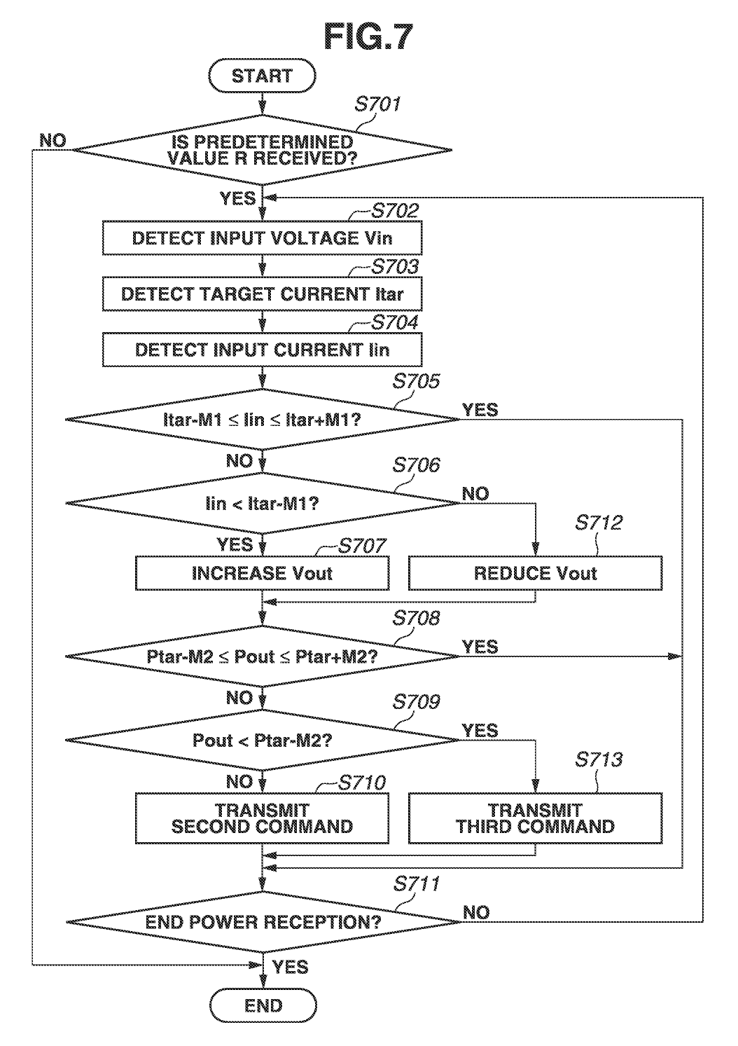

The control process performed in step S606 illustrated in FIG. 6 will be described with reference to a flowchart illustrated in FIG. 7.

After the first command is transmitted from the electronic apparatus 200 to the power transmitting apparatus 100, the power transmitting apparatus 100 transmits the predetermined value R calculated in step S504 to the electronic apparatus 200.

Then, in step S701, the control unit 209 determines whether the predetermined value R is received by the communication unit 204 from the power transmitting apparatus 100. If the predetermined value R is received by the communication unit 204 (YES in step S701), the process proceeds to step S702. If the predetermined value R is not received by the communication unit 204 (NO in step S701), the present flowchart ends. In step S702, the control unit 209 controls the load control unit 206a in such a manner that the load control unit 206a detects the input voltage Vin. After the input voltage Vin is detected, the process proceeds to step S703.

In step S703, the control unit 209 detects a target current Itar. The control unit 209 calculates the target current Itar by dividing the input voltage Vin detected in step S702 by the predetermined value R acquired from the power transmitting apparatus 100 in step S701. The target current Itar is used as a target value based on which the current of the load unit 205 is controlled to increase the power transmission efficiency. After the target current Itar is detected, the process proceeds to step S704. In step S704, the control unit 209 controls the load control unit 206a in such a manner that the load control unit 206a detects the input current Iin. After the input current Iin is detected, the process proceeds to step S705.

In step S705, the control unit 209 determines whether the input current Iin detected in step S704 is Itar−M1 or higher, and Itar+M1 or lower. In this step, M1 is a margin with respect to the target current Itar. For example, the margin M1 is 10 [mA].

If the control unit 209 determines that the input current Iin is Itar−M1 or higher, and Itar+M1 or lower (YES in step S705), the process proceeds to step S711. If the input current Iin is Itar−M1 or higher, and Itar+M1 or lower (YES in step S705), this means that a difference between the impedance of the load unit 205 and the predetermined value R is small. When the difference between the impedance of the load unit 205 and the predetermined value R is small, the power transmission efficiency can be increased. Therefore, if the difference between the impedance of the load unit 205 and the predetermined value R is small, the control unit 209 performs a process for monitoring the input current Iin and maintaining the value of the impedance of the load unit 205 until an end of the power reception from the power transmitting apparatus 100.

If the input current Iin is not Itar−M1 or higher (NO in step S705), i.e., if the input current Iin is lower than Itar−M1, the process proceeds to step S706. If the input current Iin is not Itar+M1 or lower (NO in step S705), i.e., if the input current Iin is higher than Itar+M1, the process proceeds to step S706.

In step S706, the control unit 209 determines whether the input current Iin is lower than Itar−M1. If the input current Iin is lower than Itar−M1 (YES in step S706), the process proceeds to step S707. If the input current Iin is not lower than Itar−M1 (NO in step S706), i.e., if the input current Iin is higher than Itar+M1, the process proceeds to step S712.

When the input current Iin is lower than Itar−M1 (YES in step S706), the power transmission efficiency is reduced. In this case, the control unit 209 has to increase the input current Iin to Itar−M1 or higher to improve the power transmission efficiency. Therefore, in step S707, the control unit 209 controls the load control unit 206a in such a manner that the load control unit 206a increases the voltage Vout, which is the voltage output from the converter 206c, from the present voltage value so as to increase the input current Iin to Itar−M1 or higher. After that, the process proceeds to step S708.

In step S708, the control unit 209 detects output power Pout from a product of the output voltage Vout detected by the load control unit 206a and the output current lout detected by the load control unit 206a. Further, the control unit 209 detects target power Ptar from a product of the input voltage Vin detected by the load control unit 206a and the target current Itar detected in step S703. Further, in step S708, the control unit 209 determines whether the output power Pout is Ptar−M2 or more, and Ptar+M2 or less. In step S708, M2 is a margin with respect to the target power Ptar. For example, the margin M2 is 0.2 [W].

If the control unit 209 determines that the output power Pout is Ptar−M2 or more, and Ptar+M2 or less (YES in step S708), the process proceeds to step S711. If the output power Pout is Ptar−M2 or more, and Ptar+M2 or less (YES in step S708), the control unit 209 determines that the adjustment unit 206 supplies power required for the system unit 207 with the power received from the power transmitting apparatus 100. The power required for the system unit 207 includes, for example, power used for the charging control unit 211 to charge the battery 212, power to allow the control unit 209 to operate, power to allow the recording unit 213 to operate, and power to allow the imaging unit 215 to operate.

If the output power Pout is not Ptar−M2 or more (NO in step S708), i.e., if the output power Pout is less than Ptar−M2, the process proceeds to step S709. If the output power Pout is not Ptar+M2 or less (NO in step S708), i.e., if the output power Pout is more than Ptar+M2, the process proceeds to step S709.

In step S709, the control unit 209 determines whether the output power Pout is less than Ptar−M2. If the output power Pout is less than Ptar−M2 (YES in step S709), the process proceeds to step S713. If the output power Pout is not less than Ptar−M2 (NO in step S709), i.e., if the output power Pout is more than Ptar+M2, the process proceeds to step S710.

If the output power Pout is more than Ptar+M2 (NO in step S709), the control unit 209 determines that the adjustment unit 206 cannot supply the power required for the system unit 207 because the power received from the power transmitting apparatus 100 is insufficient. Therefore, in step S710, the control unit 209 controls the communication unit 204 in such a manner that the communication unit 204 transmits the second command for requesting an increase in the power-transmission power. Then, the process proceeds to step S711.

In step S711, the control unit 209 determines whether to end the reception of the power-transmission power from the power transmitting apparatus 100. For example, if the control unit 209 detects that the charging of the battery 212 is completed according to the remaining capacity information, the control unit 209 determines to end the reception of the power-transmission power from the power transmitting apparatus 100. On the other hand, if the control unit 209 detects that the charging of the battery 212 is not completed according to the remaining capacity information, the control unit 209 determines not to end the reception of the power-transmission power from the power transmitting apparatus 100.

Further, for example, if the control unit 209 detects that power consumption of the electronic apparatus 200 falls to or below predetermined power consumption, the control unit 209 determines to end the reception of the power-transmission power from the power transmitting apparatus 100. On the other hand, if the control unit 209 detects that the power consumption of the electronic apparatus 200 does not fall to or below the predetermined power consumption, the control unit 209 determines not to end the reception of the power-transmission power from the power transmitting apparatus 100.

If the control unit 209 determines not to end the reception of the power-transmission power from the power transmitting apparatus 100 (NO in step S711), the process returns to step S702. If the control unit 209 determines to end the reception of the power-transmission power from the power transmitting apparatus 100 (YES in step S711), the present flowchart ends. Then, the process proceeds to step S607.

If the input current Iin is higher than Itar+M1 (NO in step S706), the power transmission efficiency is reduced. In this case, the control unit 209 has to reduce the input current Iin to Itar+M1 or lower to improve the power transmission efficiency. Therefore, in step S712, the control unit 209 controls the load control unit 206a in such a manner that the load control unit 206a reduces the output voltage Vout, which is the voltage output from the converter 206c, from the present voltage value so as to reduce the input current Iin to Itar+M1 or lower. After that, the process proceeds to step S708.

If the output power Pout is less than Ptar−M2 (YES in step S709), the control unit 209 determines that the adjustment unit 209 can supply the power required for the system unit 207 with the power received from the power transmitting apparatus 100. Further, the control unit 209 determines that excessive power more than the power required for the system unit 207 is received from the power transmitting apparatus 100. Therefore, in step S713, the control unit 209 controls the communication unit 204 in such a manner that the communication unit 204 transmits the third command for requesting a reduction in the power-transmission power. Then, the process proceeds to step S711.

In this manner, the electronic apparatus 200 sets the impedance of the load unit 205 so as to increase the power transmission efficiency with use of the predetermined value R received from the power transmitting apparatus 100. After that, the electronic apparatus 200 controls the impedance of the load unit 205 in such a manner that the power transmission efficiency is not reduced until the end of the reception of the power transmitted from the power transmitting apparatus 100. In this manner, the electronic apparatus 200 performs control in such a manner that the impedance of the load unit 205 is not suddenly changed, thereby, the power transmission efficiency can be prevented from being reduced. Therefore, the electronic apparatus 200 can receive sufficient power from the power transmitting apparatus 100.

Further, when the power required for the system unit 207 cannot be supplied with the power received from the power transmitting apparatus 100 after the impedance of the load unit 205 is controlled, the electronic apparatus 200 requests the power transmitting apparatus 100 to increase the power-transmission power. As a result, the electronic apparatus 200 can receive sufficient power from the power transmitting apparatus 100, even when the electronic apparatus 200 controls the impedance of the load unit 205 to increase the power transmission efficiency.

In step S708 illustrated in FIG. 7, the control unit 209 detects the target power Ptar from the product of the input voltage Vin and the target current Itar. However, in step S708, the control unit 209 may detect the target power Ptar based on the input voltage Vin, the target current Itar, and a coefficient regarding voltage conversion efficiency of the converter 206c.

Further, in FIG. 7, if the control unit 209 determines NO in step S711, the process returns to step S702, and the control unit 209 controls the impedance of the load unit 205 again with use of the predetermined value R acquired from the power transmitting apparatus 100. However, if the control unit 209 determines NO in step S711, the process may return to step S603 illustrated in FIG. 6, and the control process illustrated in FIG. 7 may be performed again after the predetermined value R is reacquired from the power transmitting apparatus 100. In this case, for example, even if a change occurs in a position of the electronic apparatus 200 relative to the power transmitting apparatus 100, the electronic apparatus 200 can reacquire the predetermined value R in which an influence of the change in the position of the electronic apparatus 200 is reflected. Therefore, the electronic apparatus 200 can more accurately control the impedance of the load unit 205.

The first exemplary embodiment has been described assuming that the margin M1 is 10 [mA]. However, the margin M1 may be another value than 10 [mA]. The first exemplary embodiment has been described assuming that the margin M2 is 0.2 [W]. However, the margin M2 may be another value than 0.2 [W].

In the first exemplary embodiment, the matching circuit 104 includes the variable capacitor 104a and the variable capacitor 104b. However, the first exemplary embodiment is not limited thereto.

For example, the matching circuit 104 may further include a variable coil, in addition to the variable capacitor 104a and the variable capacitor 104b. In this case, the control unit 101 calculates the Quality Factor Qtx with use of not only the value of the inductance of the coil Ltx but also a value of an inductance of the variable coil included in the matching circuit 104.

Further, for example, the matching circuit 104 may further include a variable resistance, in addition to the variable capacitor 104a and the variable capacitor 104b. In this case, the control unit 101 calculates the Quality Factor Qtx with use of not only the value of the impedance of the internal resistance Rtx but also a value of an impedance of the variable resistance included in the matching circuit 104.

Further, for example, the variable capacitor 104a and the variable capacitor 104b are connected in series with the power transmitting antenna 105, but at least one of the variable capacitor 104a and the variable capacitor 104b may be connected in parallel with the power transmitting antenna 105.

In the first exemplary embodiment, the matching circuit 202 includes the variable capacitor 202a and the variable capacitor 202b. However, the first exemplary embodiment is not limited thereto.

For example, the matching circuit 202 may further include a variable coil, in addition to the variable capacitor 202a and the variable capacitor 202b. In this case, the control unit 209 calculates the Quality Factor Qrx with use of not only the value of the inductance of the coil Lrx but also a value of an inductance of the variable coil included in the matching circuit 202.

Further, for example, the matching circuit 202 may further include a variable resistance, in addition to the variable capacitor 202a and the variable capacitor 202b. In this case, the control unit 209 calculates the Quality Factor Qrx with use of not only the value of the impedance of the internal resistance Rrx but also a value of an impedance of the variable resistance included in the matching circuit 202.

Further, for example, the variable capacitor 202a and the variable capacitor 202b are connected in series with the power receiving antenna 201, but at least one of the variable capacitor 202a and the variable capacitor 202b may be connected in parallel with the power receiving antenna 201.

In the first exemplary embodiment, the power transmitting apparatus 100 and the electronic apparatus 200 perform communication therebetween according to the protocol defined by the NFC standards. However, the power transmitting apparatus 100 and the electronic apparatus 200 may perform communication therebetween based on a protocol defined by Radio Frequency Identification (RFID), instead of the protocol defined by the NFC standards. Alternatively, the power transmitting apparatus 100 and the electronic apparatus 200 may perform communication therebetween based on a protocol defined by International Organization for Standardization (ISO) 14443 or ISO 15693, instead of the protocol defined by the NFC standards. Further alternatively, the power transmitting apparatus 100 and the electronic apparatus 200 may perform communication therebetween based on a protocol defined by the Bluetooth (registered trademark) standard or the wireless Local Area Network (LAN) standard, instead of the protocol defined by the NFC standards.

### Other Embodiments

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-023829 filed Feb. 10, 2014, which is hereby incorporated by reference herein in its entirety.

What is claimed is:

1. An electronic apparatus comprising:
a power receiving unit configured to wirelessly receive power from a power transmitting apparatus;
a supply unit configured to supply power received by the power receiving unit to a load unit; and
a control unit configured to perform control such that an impedance of the load unit matches a predetermined impedance,
wherein the predetermined impedance is set based on a Quality Factor relating to the electronic apparatus and a value indicating a level of coupling between the power transmitting apparatus and the electronic apparatus.

2. The electronic apparatus according to claim 1, wherein the predetermined impedance is further set based on a Quality Factor relating to the power transmitting apparatus.

3. The electronic apparatus according to claim 2, wherein the Quality Factor relating to the power transmitting apparatus is a value relating to a characteristic of resonance of the power transmitting apparatus.

4. The electronic apparatus according to claim 1, wherein the Quality Factor relating to the electronic apparatus is a value relating to a characteristic of resonance of the electronic apparatus.

5. The electronic apparatus according to claim 1, further comprising a communication unit configured to perform wireless communication with the power transmitting apparatus,
wherein the control unit causes the communication unit to transmit data for controlling power output from the power transmitting apparatus based on whether a difference between power used by the load unit and power received by the power receiving unit is a predetermined value or larger.

6. The electronic apparatus according to claim 5, wherein the control unit causes the communication unit to transmit data for reducing power, output from the power transmitting apparatus if the power used by the load unit is less than the power received by the power receiving unit, by the predetermined value or larger.

7. The electronic apparatus according to claim 5, wherein the control unit causes the communication unit to transmit data for increasing power, output from the power transmitting apparatus if the power used by the load unit is more than the power received by the power receiving unit, by the predetermined value or larger.

8. A method for controlling an electronic apparatus, the method comprising:
wirelessly receiving power from a power transmitting apparatus;
supplying power received from the power transmitting apparatus to a load unit connected to the electronic apparatus; and
performing control such that an impedance of the load unit matches a predetermined impedance,
wherein the predetermined impedance is set based on a Quality Factor relating to the electronic apparatus and a value indicating a level of coupling between the power transmitting apparatus and the electronic apparatus.

9. A storage medium storing computer executable instructions for causing a computer to perform a method for controlling an electronic apparatus, the method comprising:
wirelessly receiving power from a power transmitting apparatus;
supplying power received from the power transmitting apparatus to a load unit connected to the electronic apparatus; and
performing control such that an impedance of the load unit matches a predetermined impedance,
wherein the predetermined impedance is set based on a Quality Factor relating to the electronic apparatus and a value indicating a level of coupling between the power transmitting apparatus and the electronic apparatus.

10. A power transmitting apparatus comprising:
a power transmitting unit configured to wirelessly transmit power to an electronic apparatus;
a communication unit configured to perform wireless communication with the electronic apparatus; and
a control unit configured to control the communication unit such that the communication unit transmits, to the electronic apparatus, data indicating a predetermined impedance for causing the electronic apparatus to control an impedance of a load unit connected to the electronic apparatus,
wherein the predetermined impedance is set based on a Quality Factor relating to the power transmitting apparatus and a value indicating a level of coupling between the power transmitting apparatus and the electronic apparatus.

11. The power transmitting apparatus according to claim 10, wherein the predetermined impedance is further set based on a Quality Factor relating to the electronic apparatus.

12. The power transmitting apparatus according to claim 11, wherein the Quality Factor relating to the electronic apparatus is a value relating to a characteristic of resonance of the electronic apparatus.

13. The power transmitting apparatus according to claim 10, wherein the Quality Factor relating to the power transmitting apparatus is a value relating to a characteristic of resonance of the power transmitting apparatus.

14. The power transmitting apparatus according to claim 10, wherein the control unit controls power to be transmitted to the electronic apparatus via the power transmitting unit according to a request from the electronic apparatus.

15. A method for controlling a power transmitting apparatus, the method comprising:
wirelessly transmitting power to an electronic apparatus; and
transmitting, to the electronic apparatus, data indicating a predetermined impedance for causing the electronic apparatus to control an impedance of a load unit connected to the electronic apparatus,
wherein the predetermined impedance is set based on a Quality Factor relating to the power transmitting apparatus and a value indicating a level of coupling between the power transmitting apparatus and the electronic apparatus.

16. A storage medium storing computer executable instructions for causing a computer to perform a method for controlling a power transmitting apparatus, the method comprising:
wirelessly transmitting power to an electronic apparatus; and
transmitting, to the electronic apparatus, data indicating a predetermined impedance for causing the electronic apparatus to control an impedance of a load unit connected to the electronic apparatus,
wherein the predetermined impedance is set based on a Quality Factor relating to the power transmitting apparatus and a value indicating a level of coupling between the power transmitting apparatus and the electronic apparatus.
